(19) United States
(12) Patent Application Publication
(10) Pub. No.: US 2009/0237243 A1
(43) Pub. Date: Sep. 24, 2009

(54) PROTECTIVE CASE HAVING A LIGHT-ACTIVATED SOUND CHIP POSITIONED BENEATH A LINER SHAPED TO HOLD A READABLE CARD

(76) Inventors: Eric Davis Child, Highland, UT (US); Joshua David Nelson, Provo, UT (US); Reed Michael Quinn, Orem, UT (US)

Correspondence Address: ANGUS C. FOX, III, 4093 N. IMPERIAL WAY, PROVO, UT, 84604-5386, US

(21) Appl. No.: 12/052,734

(22) Filed: Mar. 21, 2008

(51) Int. Cl. G08B 21/00; G06K 7/00

(52) U.S. Cl. 340/540; 235/486

(57) ABSTRACT

A protective case incorporates a light-activated sound chip playback system that is largely hidden beneath a liner shaped to hold a readable card. The case includes a receptacle having an opening; a lid sized to fit over the opening; a semi-rigid liner shaped to generally fill the receptacle, the liner having a storage location for a readable card, such as a gift card, credit card or smart card, the liner being formed of generally laminar material so as to leave a void between an upper interior surface of the liner and an interior bottom surface of said receptacle; and an electrochemical-cell-powered sound playback system positioned generally within the void, the sound playback system having a light-activated switch which activates sound playback when said lid is removed from said receptacle.₍₁₃₄₎

### BACKGROUND OF THE INVENTION

1. Field of the Invention

The invention relates, generally, to gift card holders and containers and, more particularly, to a protective case in which a readable card can be stored, the case having a lid, as well as a battery-powered sound chip that is activated by exposure of a photoelectric switch to light by removal of the lid.

2. History of the Prior Art

U.S. Pat. No. 7,163,152 to Warren R. Osborn and Bryan P. Dunford discloses a protective metal container for storing and carrying gift cards, credit cards and smart cards. The container shields the enclosed card, or cards, from potentially damaging magnetic and electromagnetic fields, thereby greatly reducing the possibility that information stored on the card will be erased. A preferred embodiment container for protecting cards having magnetically-encoded information thereon is stamped and formed from sheet metal containing nickel and iron, which has high magnetic permeability. Other embodiments of the container, which provide less, yet generally acceptable protection from unwanted magnetic fields, are stamped from mild steel. A preferred embodiment container for protecting smart cards, which typically have an embedded integrated circuit, are also stamped from metal, which is dielectrically coated. The container acts as a Faraday cage, which prevents damage to the smart card from static electric discharges. In both cases, the card is stored within an liner made of polymeric plastic material, which has neither magnetic permeability nor appreciable electrical conductivity.

In 1987, Integrated Storage Devices (ISD) began developing a unique record/playback technology called ChipCorder®. By exploiting a previously unused characteristic of EEPROM memory, ISD was able to store different voltage levels, not just ones and zeros, in each memory cell. By sampling and storing an analog audio signal directly into these memory cells, without digitization, ISD was able to make high quality audio recordings on a single chip. The adaptation of an EEPROM memory—which was theretofore considered to be essentially a digital product—for analog audio storage was a revolutionary idea. ChipCorder devices, which can directly store an audio signal with eight times as much resolution as a similarly sized digital storage device, have a sampling frequency range of 4.0 Hz to 12.0 KHz, and are available with record and playback durations from 6 seconds to 17 minutes. Amazingly, this multi-level storage (MLS) technology enabled ISD to provide a complete, single chip solution for voice and audio recording and playback. ISD was subsequently purchased by Winbond Electronics Corporation, a Taiwan-based company which was also founded in 1987.

For a score of years, ChipCorder devices have been incorporated extensively in novelty applications, such as givaways, talking key chains, photo frames, recording pens, and greeting cards; in automotive applications, such as remote keyless entry systems, door chimes, audible warnings, and radar detectors; in industrial applications, such as warning signals, vending machines, bus and subway announcement systems; in telecommunication applications, such as answering machines and central office equipment; and in home appliances, such as refrigerators and microwave ovens.

For most applications, a complete ChipCorder playback system includes a small single-layer circuit board (a typical size is about 17 mm×20 mm) to which the single chip ChipCorder device is soldered to a mounting pad. The circuit board provides at least one mounting location for a power cell, and terminals for connecting both an audio speaker and an ON-OFF switch.

Greeting cards are likely the most widely-recognized use of single-chip MLS storage devices. Typically, the ChipCorder device is installed so that as the greeting card is opened, a switch is activated, thereby providing power the ChipCorder device, which generally plays a song or verbal message.

A sound chip incorporated in a simulated product container (e.g., can of beer) is disclosed in U.S. Pat. No. 5,099,232 to Howes. The container, which is filled with a liquid or dry material to simulate the weight and feel of the simulated product, includes a mechanical switch that activates playback of a recorded song or message when the container is opened.

A business card holder which incorporates a sound chip is disclosed in U.S. Pat. No. 5,275,285 to Timothy P. Clegg.

A delivery system for delivering an item accompanied by special effects is disclosed in U.S. Pat. No. 5,762,194, which also issued to Timothy P. Clegg. The delivery system includes a tube having a cap. Connected to the cap is a sound chip, a light sensor, and a clip for holding an item such as a card. When the container is closed with the cap, the sound chip, light sensor, clip and held item are disposed within the container. When the cap is removed, the light sensor activates the sound chip, which plays a song, applause, or a verbal message. The enclosed card can then be viewed by the recipient of the container while the sound chip playback is active.

U.S. Pat. No. 6,298,990 to Barbara J. Amrod, et al. discloses a container that includes a sound assembly mounted thereon. The sound assembly includes a sound chip activated by a light sensor when the container is opened.

What is needed is a covered tin which not only protects credit cards and smart cards from strong stray magnetic fields and static electricity, but which also incorporates a sound chip playback system that is virtually undetectable when the case is opened by a recipient.

### SUMMARY OF THE INVENTION

A primary object of the present invention is the incorporation of a sound chip playback system in a protective case for storing and carrying a readable card. The invention is disclosed in the context of incorporating such a sound chip playback system in one of the embodiments of covered metal containers disclosed in U.S. Pat. No. 7,163,152. A covered metal tin having a polymeric liner serves as a gift box for the protective storage and transport of gift cards, credit cards, and smart cards, which have either magnetically-coded information stored thereon or a querryable integrated circuit, such as a radio-frequency identification tag. The covered tin is designed to protect the enclosed card from strong magnetic fields and from static electricity which could either erase information that is magnetically encoded on a magnetic card, or destroy integrated circuitry on a smart card. The covered tin incorporates a sound chip playback system that is activated when the container is opened and light (i.e., electromagnetic radiation in the visible spectrum) impinges on a light-activated switch, such as a light-dependent resistor (LDR). When subjected to light, the LDR feeds battery power to the sound chip, which plays a sound recording through an audio speaker.

Thus, one embodiment of the protective case for holding a readable card includes a receptacle and lid, both of which are stamped and formed from sheet metal. The gift card tin also includes a magnetically nonpermeable, polymeric plastic liner that is installed within the receptacle. The plastic liner may be vacuum formed or injection molded. The liner has a recess for holding a stored card therein. The recess is equipped with at least two tabs which retain the card in the recess. The recess prevents the card from contacting the metal portion of the protective case, and thereby prevents magnetic lines of force from being diverted from the metal portion to the magnetic particles on the card. In addition, the gift card tin, when in a closed configuration provides what is essentially a Faraday cage around a card that is stored within the polymeric plastic liner, thereby protecting sensitive integrated circuits in a stored smart card from static electrical discharges. For a preferred embodiment of the invention, the sound chip playback system is entirely disposed beneath the upper surface of the polymeric plastic liner. The entire sound chip playback system is attached to the underside of the polymeric plastic liner using an adhesive or an adhesive backed tape. The audio speaker of the playback system is bonded directly to the underside of the card recess so that the entire plastic liner becomes a functional part of the speaker. An aperture is punched, drilled, molded, or otherwise formed in the upper surface of the polymeric plastic liner. The light sensitive element of the playback system is disposed beneath the aperture, which need be no more than about 5 mm in diameter. The sensor is the only portion of the playback system that is visible when the cover is removed. Alternatively, a transparent window can be bonded beneath the aperture and the sensor can be positioned in contact with the window below the aperture.

For other embodiments of the protective case, the receptacle and lid may be fabricated from polymeric plastic material, wood and paper. Likewise, the liner of the receptacle can also be made of metal, polymeric plastic material, wood and paper.

### BRIEF DESCRIPTION OF THE DRAWINGS (PHOTOGRAPHS)

FIG. 1 is an upper projection isometric view of a covered tin having a light-activated sound chip playback system positioned beneath a liner shaped to hold a gift card, which is also shown;

FIG. 2 is a lower projection isometric view of a covered tin having a light-activated sound chip playback system positioned beneath a liner shaped to hold a gift card, which is also shown;

FIG. 3 is an upper projection isometric exploded view of a covered tin having a light-activated sound chip playback system positioned beneath a liner shaped to hold a gift card, which is also shown;

FIG. 4 is an upper projection isometric exploded view of a covered tin having a light-activated sound chip playback system positioned beneath a liner shaped to hold a gift card, which is also shown;

FIG. 5 is an exploded side elevational view of a covered tin having a light-activated sound chip playback system positioned beneath a liner shaped to hold a gift card;

FIG. 6 is an exploded end elevational view of a covered tin having a light-activated sound chip playback system positioned beneath a liner shaped to hold a gift card;

FIG. 7 is an upper projection isometric view of the liner having a light activated sound chip playback system positioned on an under side thereof;

FIG. 8 is a lower projection isometric view of the liner having a light-activated sound chip positioned on an under side thereof;

FIG. 9 is a top plan view of the liner having a light-activated sound chip playback system positioned on an under side thereof;

FIG. 10 is a bottom plan view of the liner having a light-activated sound chip playback system positioned on an under side thereof;

FIG. 11 is a bottom plan view of the light-activated sound chip playback system, including the audio speaker;

FIG. 12 is a top plan view of the light-activated sound chip playback system, including the audio speaker; and

FIG. 13 is a bottom isometric view of an alternative, one-piece receptacle.

### DETAILED DISCLOSURE OF THE INVENTION

A primary focus of the present invention is the incorporation of a sound chip playback system in a protective case for storing and carrying a readable card. The invention is disclosed in the context of incorporating such a sound chip playback system in one of the embodiments of covered metal containers disclosed in U.S. Pat. No. 7,163,152. A covered metal tin having a polymeric liner serves as a gift box for the protective storage and transport of gift cards, credit cards, and smart cards, which have either magnetically-coded information stored thereon or a querryable integrated circuit, such as a radio-frequency identification tag. The covered tin is designed to protect the enclosed card from strong magnetic fields and from static electricity which could either erase information that is magnetically encoded on a magnetic card, or destroy integrated circuitry on a smart card. A sound chip playback system, which is mounted beneath the polymeric liner, is activated when the container is opened and light (i.e., electromagnetic radiation in the visible spectrum) impinges on a light-dependent resistor, thereby supplying power from an electrochemical cell to a sound chip and audio speaker. The covered tin having a light-activated sound chip positioned beneath the liner shaped to hold a gift card will now be described in detail with reference to the attached drawing figures.

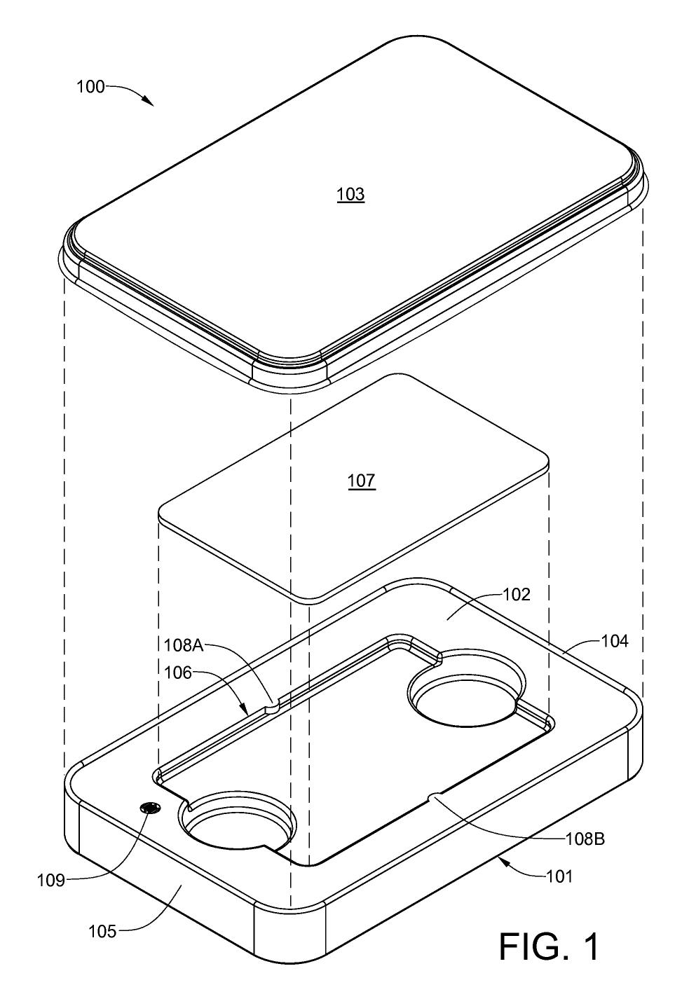

Referring now to FIG. 1, a gift card tin having a light-activated sound chip playback system 100 includes a receptacle 101, a polymeric plastic liner 102, and a press-on friction-fit lid 103. It will be noted that the liner 102 snaps into the receptacle 101, and is held in place by a first bead 104 on an upper edge of the side wall 105 of receptacle 101. The polymeric plastic liner 102 may formed using one of several readily available techniques, such as vacuum forming or injection molding. The polymeric plastic liner, which is formed from any of a variety of thermoplastic or thermosetting resins, which may include polystyrene, ABS, polyvinylchloride, acrylic or polycarbonate, includes a recess 106 in which a gift card 107 can be stored. The recess 106 has a pair of opposed projections 108A and 108B, which secure the gift card 107 in the recess 106. The light-activated sound chip playback system is mounted below the liner 102. Only the light-activated switch 109 of that system is visible through an aperture punched, molded, or otherwise formed in the liner 102. The receptacle 101 and lid 103 are preferably fabricated from a ferromagnetic sheet metal, such as mild steel, or a metal alloy having enhanced magnetic permeability containing nickel and iron, and are designed to protect an enclosed card from magnetic fields and static electrical discharges. For optimum protection from stray magnetic fields, the metal alloy may have about 80% nickel and 15% iron by weight, with the balance being copper, molybdenum or chromium.

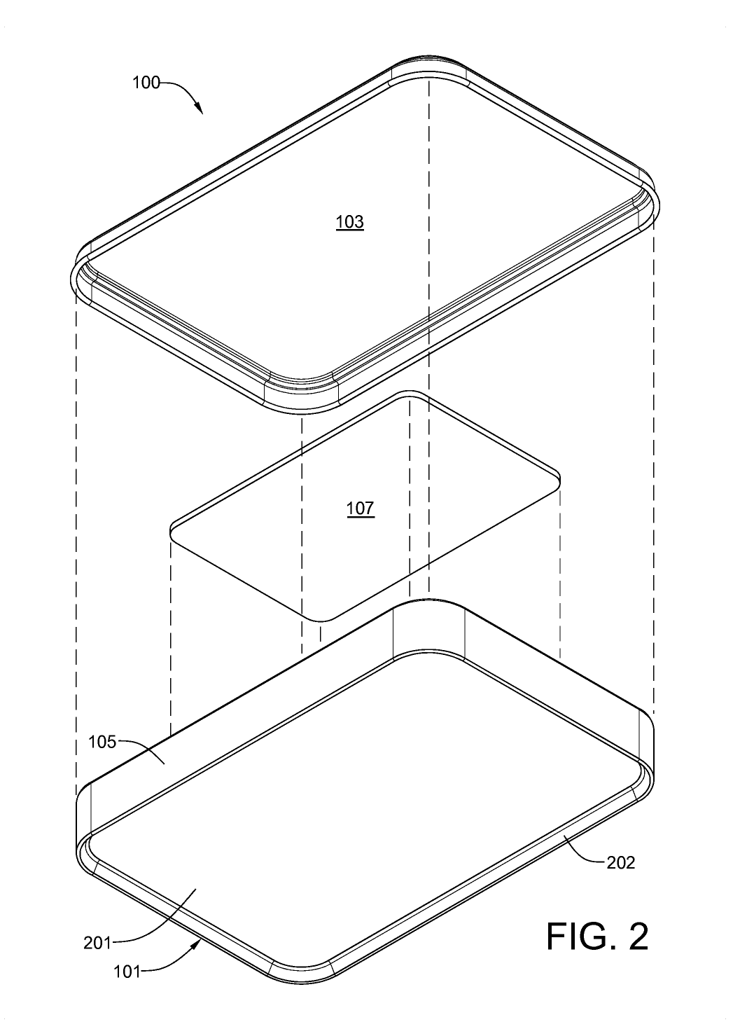

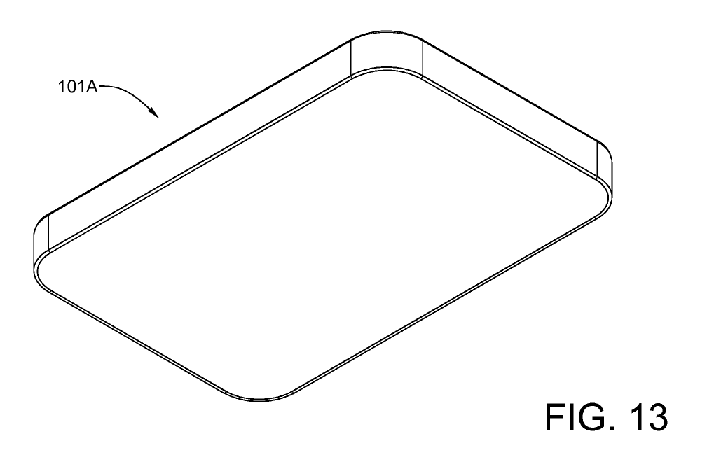

Referring now to FIG. 2, the gift card tin having a light-activated sound chip playback system 100 is seen from a different angle. For this particular first embodiment protective case 100, the lid 103 is stamped and formed from a single piece of sheet metal. The receptacle 101 is formed from two pieces: a first piece for the side wall 105, and a second piece for the bottom panel 201. The bottom panel 201 is retained by a second bead 202 on a lower edge of the side wall 105 and by the liner 102, which is retained by the first bead 104. Alternatively, the side wall 105, first bead 104, and bottom panel 201 can be formed from a single continuous piece of sheet metal. This alternative embodiment receptacle 101A is shown in FIG. 13.

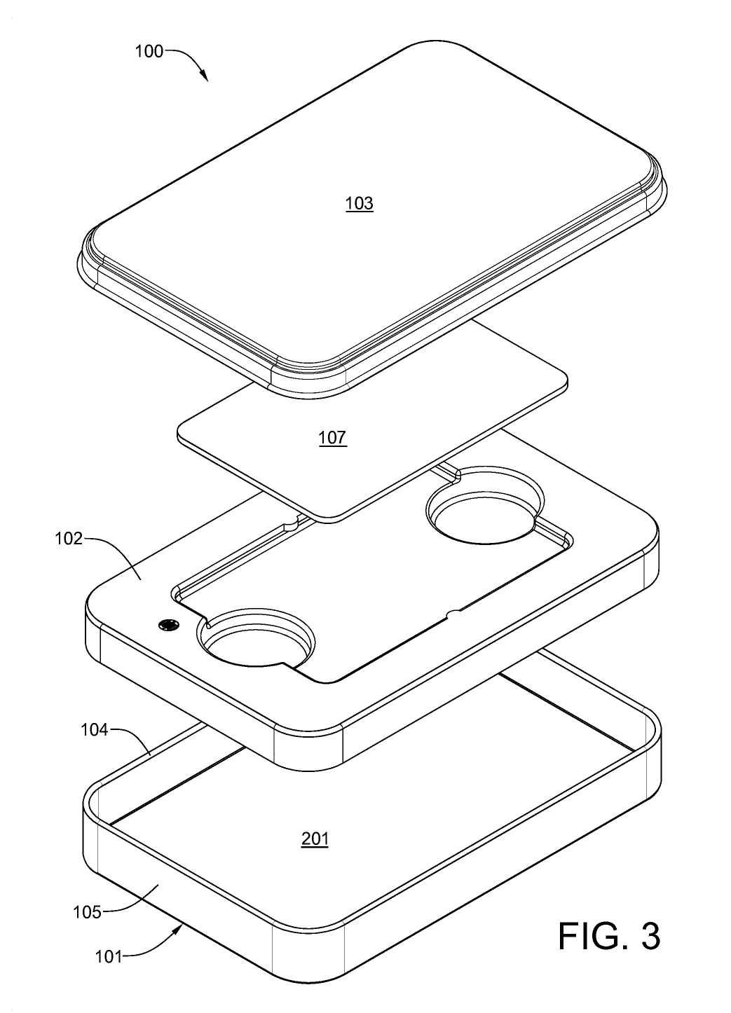

Referring now to FIG. 3, this exploded view of the first embodiment protective case 100 from above shows the interior of the receptacle 101 and greater detail of the liner 102.

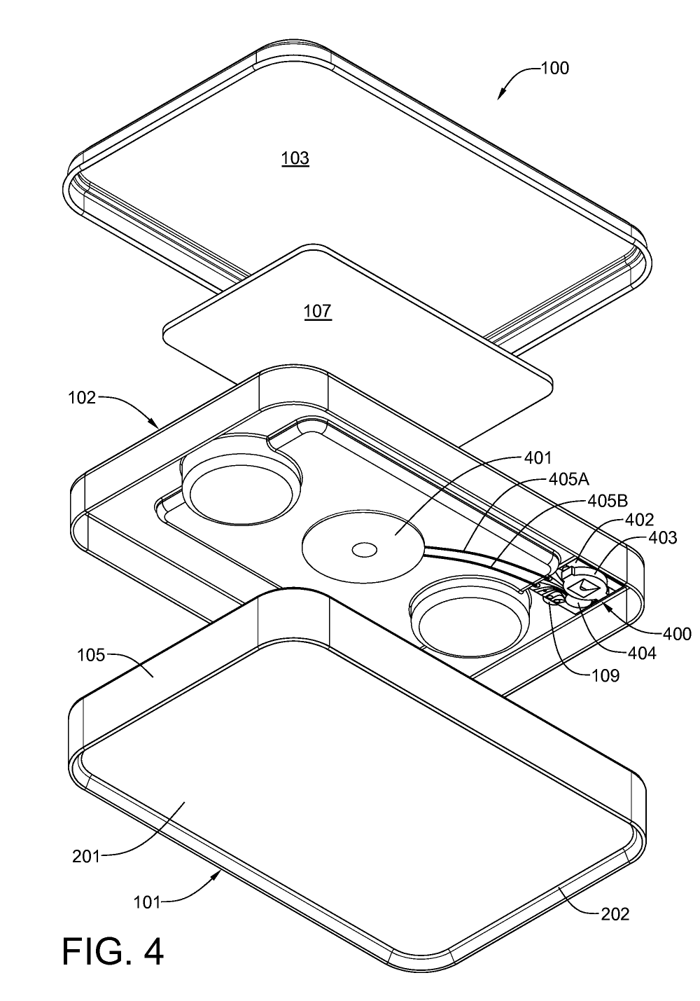

Referring now to FIG. 4, this exploded view of the first embodiment protective case 100 from below show additional details of the liner 102. Certain portions of the sound chip playback system 400 are partially visible in this view, including an audio speaker 401, a miniature circuit board 402, an electrochemical cell 403, which powers the sound chip playback system 400, a sound chip 404, the light-activated switch 109, and wires 405A and 405B which interconnect the audio speaker 401 and the miniature circuit board 402.

The sound chip 404 is preferably an integrated single chip, which utilizes a multi-level storage EEPROM memory for analog audio storage and playback. Originally available only as ChipCorder devices from ISD (now a subsidiary of Windbond Corp. of Taiwan ROC), such chips are now available from a variety of sources. For example, Holtek Microelectronics Inc. of Taiwan ROC produces a Sound Generator chip, Model HT-2812 1, on which can also be recorded, for playback, any audio track incorporating music, vocal messages, or any other sounds in the audible spectrum.

The light-activated switch 109 may be a light-dependent resistor (LDR), such as Model CD5G208 produced by Cosmos Electronics Inc. of Tokyo, Japan. When subjected to light, the LDR feeds battery power to the sound chip 404, which plays the audio track stored in its multi-level storage EEPROM memory through the audio speaker 401.

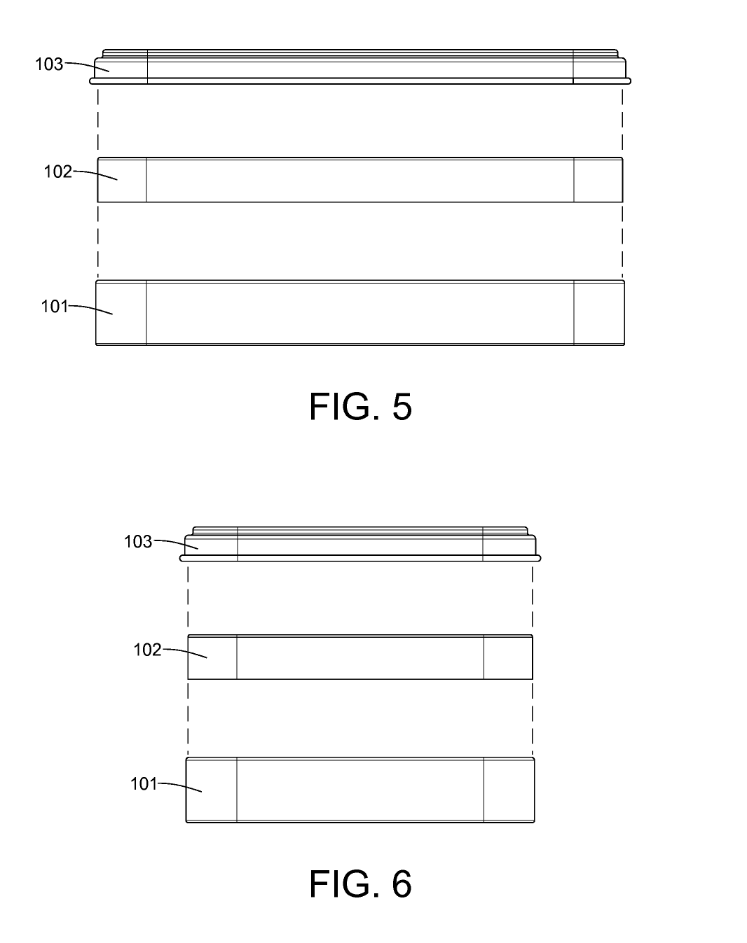

Referring now to FIGS. 5 and 6, these exploded side and end elevational views provide excellent profile views of the lid 103. No portion of the sound chip playback system 400 is visible in these views.

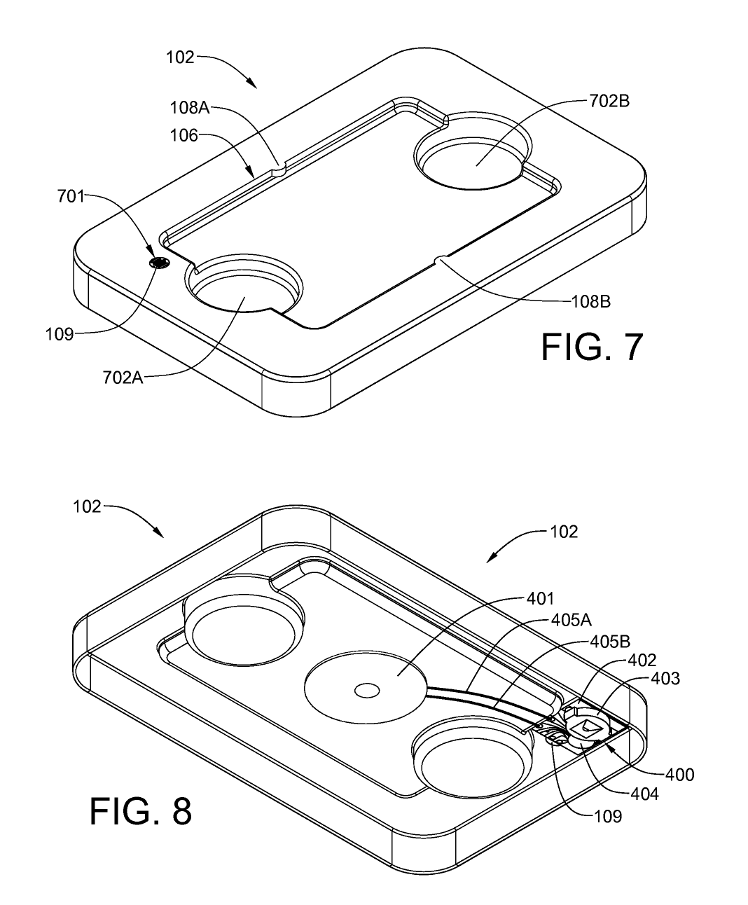

Referring now to FIG. 7, the liner 102 includes a recess 106 in which a gift card 107 can be stored. The recess 106 has a pair of opposed projections 108A and 108B, which secure the gift card 107 in the recess 106. As the liner 102 is preferably made from semi-flexible polymeric material, the liner 102 can be distorted sightly to release the card from beneath the opposed projections 108A and 108B. It will be further noted that when the gift card 107 is secured by the opposed projections 108A and 108B within the recess 106, it is prevented from touching the lid 103. The light-activated sound chip playback system 400 is mounted below the liner 102. Only the light-activated switch 109 of that system is visible through an aperture 701 that is punched, molded, or otherwise formed in the liner 102. It will be noted that a pair of finger depressions 702A and 702B are positioned at opposite ends of the recess 106, which enable the owner of the gift card tin 100 to easily remove the gift card 107 from the recess 106.

Referring now to FIG. 8, which shows the liner 102 from below, the sound chip playback system 400 can once again be partially seen.

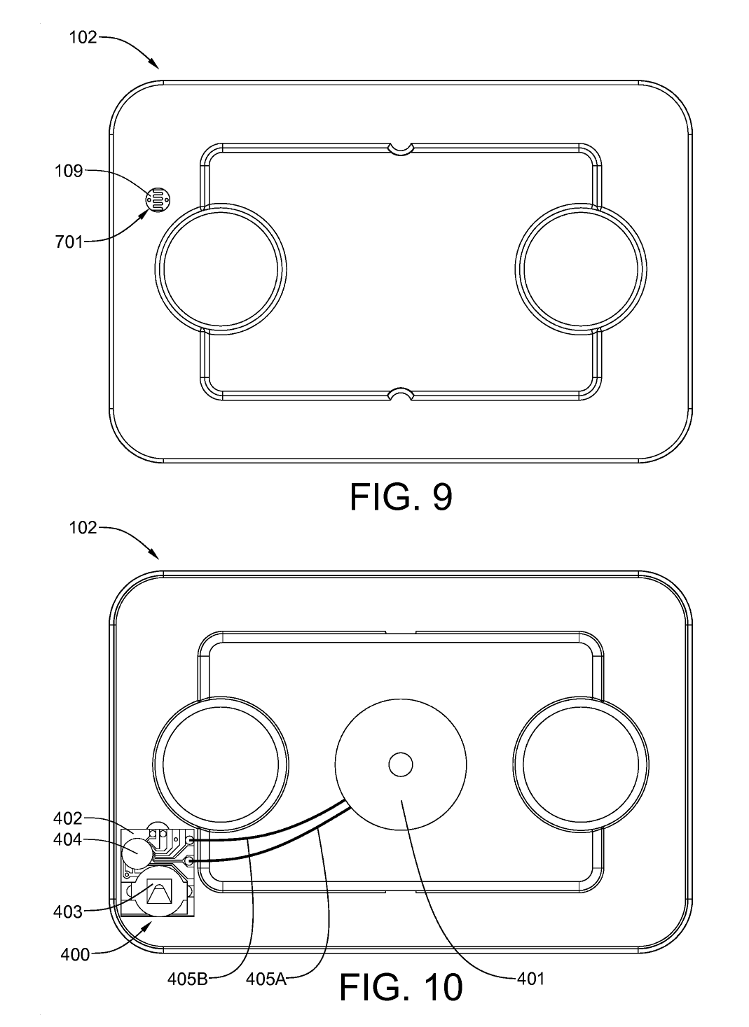

Referring now to FIG. 9, this top view of the liner 102 clearly shows the light-activated switch 109 that activates the sound chip playback system 400 when light of the visible spectrum shines thereon. The light-activated switch is positioned within an aperture 901 that is punched, drilled, molded, or otherwise formed in the liner 102. Other features of the insert 102 have already been described and are numbered consistent with the same features in previously described drawings.

Referring now to FIG. 10, the entire sound chip playback system 400 can be seen in this view, including the sound chip 404, which preferably has an integrated circuit EEPROM memory with multi-level storage (MLS) capability, and which provides a single-chip solution for voice and audio recording and playback, the audio speaker 401, a single-layer miniature circuit board 402, the electrochemical cell 403 which powers the sound chip playback system 400, the light-dependent resistor 109 which acts as a switch to direct power from the electrochemical cell 403 to the sound chip 404 when visible light impinges thereon, the wires 405A and 405B which interconnect the audio speaker 401 and the miniature circuit board 402, and.

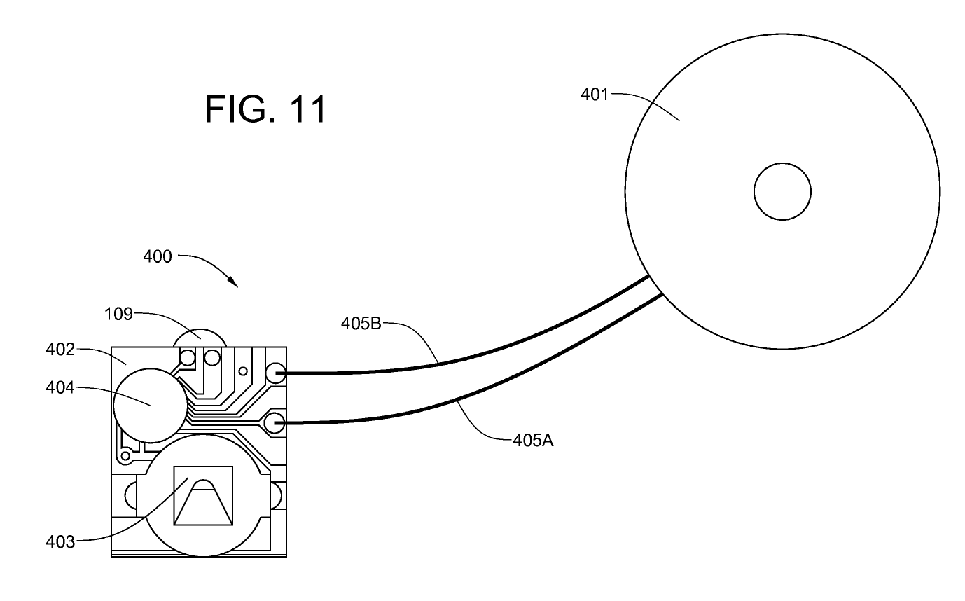

Referring now to FIG. 11, the entire sound chip playback system 400 is shown in an enlarged view. An electrochemical cell holder 1101, which is clearly visible in this view, has a spring-loaded contact 1102, which provides a constant force that causes the bottom of an installed electrochemical cell 403 to press against an electrical contact on the circuit board 402.

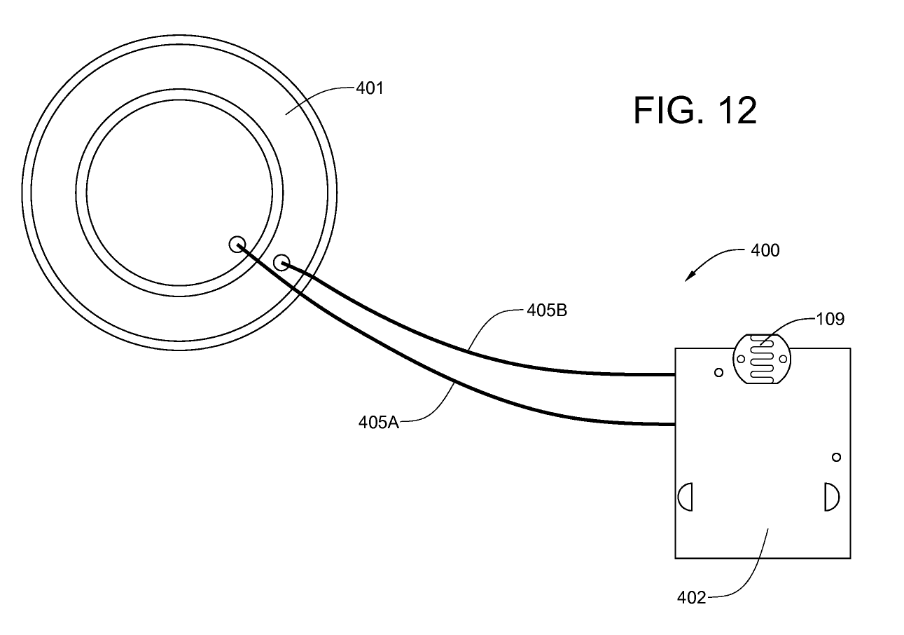

Referring now to FIG. 12, it can be seen that the light-activated switch 109 is installed on the opposite side of the miniature circuit board 402, with the leads passing through apertures on the board so that a solder connection can be made on the opposite side which has the conductive traces. The positioning of the light-activated switch 109 enables the circuit board 402 to be adhesively bonded to the underside of the insert 102, with the light-activated switch 109 positioned within the aperture 901 in the liner 102.

Although only a single embodiment of the present invention has been described in detail herein, it will be obvious to those having ordinary skill in the art that changes and modifications may be made thereto without departing from the scope and spirit of the invention as hereinafter claimed. For example, if protection of the enclosed card from electrostatic charge or stray magnetic fields is not particularly significant, the lid and receptacle may be injection molded from a polymeric plastic material. The bead at the top of a plastic receptacle, rather than being rolled into the sheet metal as in the case of the tin case, can be formed during the injection molding process. The lid and receptacle may also be made of wood or paper. In the case of wood, the receptacle may be carved or machined from a single piece, as may be the lid. Alternatively, the lid and receptacle can be made of different pieces which are cemented, glued, or otherwise bonded together. In the case of paper, the receptacle and lid can each be made of cardboard which is folded and glued. Each may also be covered with a decorative layer of paper, cloth, leather, or polymeric sheeting. The manufacture of such plastic, wood or paper boxes is well known in the art. The liner for the receptacle may be made of metal, polymeric plastic material, wood, or paper. In any case, the liner is made of laminar material and positioned above the floor of the receptacle so as to leave a void beneath the liner and the receptacle floor where the sound playback system can be positioned, with the light-sensitive switch being positioned within or below an aperture in the liner.

What is claimed is:

1. A protective case incorporating a light-activated sound chip playback system which is largely hidden beneath a liner shaped to hold a readable card, said protective case comprising:
a receptacle having an opening;
a lid sized to fit over said receptacle and cover said opening, said receptacle and said lid forming a closed container when said lid so covers said opening;
a liner shaped to generally fill said receptacle, said liner having a recess shaped to receive a readable card, said liner being formed of generally laminar material so as to leave a void between an upper interior surface of the liner and an interior bottom surface of said receptacle; and
a sound playback system positioned generally within said void, said sound playback system having at least one electrochemical cell, a sound chip having an integrated circuit memory, said sound chip being powered by said at least one electrochemical cell, and providing sound playback from the integrated circuit memory, an audio speaker that is both coupled to said sound chip and powered by said at least one electrochemical cell, and a light-activated switch which directs power from said electrochemical cell to said sound chip when electromagnetic radiation impinges thereon, said light-activated switch being the sole component of said sound playback system that is exposed and not completely covered by said liner.

2. The protective case of claim 1, wherein:
said receptacle and said lid are fabricated from a ferromagnetic sheet metal, said receptacle including a floor portion and a perimetric wall, said perimetric wall portion having an upper inner bead; and
said liner is fabricated from a semi-rigid material and able to flex sufficiently to snap into said receptacle beneath said upper inner bead.

3. The protective case of claim 1, wherein said sound playback system further comprises a miniature circuit board on which the electrochemical cell, the sound chip, and light-activated switch are mounted, said miniature circuit board having terminals to which the audio speaker is coupled.

4. The protective case of claim 1, wherein said audio speaker is adhesively bonded to said liner beneath said recess.

5. The protective case of claim 1, wherein said light-activated switch is a light-dependent resistor, and said liner includes an aperture through which light can impinge on the light-dependent resistor.

6. The protective case of claim 1, wherein said sound chip includes an EEPROM memory having multi-level storage cells.

7. The protective case of claim 1, wherein said liner is fabricated using a process selected form the group consisting of vacuum forming and injection molding.

8. A protective case incorporating a light-activated sound chip playback system which is largely hidden beneath a liner shaped to hold a readable card, said protective case comprising:
a receptacle fabricated from sheet metal, said receptacle having a floor portion and a perimetric wall portion coupled to said floor portion, said perimetric wall portion having an upper inner bead which surrounds an opening of the receptacle;
a lid fabricated from sheet metal, said lid sized to fit over said receptacle and cover said opening, said receptacle and said lid forming a closed container when said lid so covers said opening;
a liner vacuum formed from laminar semi-rigid polymeric material, said liner being shaped to fill a portion of said receptacle beneath said upper inner bead, said liner having an upper layer that formed to provide a recess shaped to receive a readable card, said liner having a downwardly-extending perimetric wall that is continuous with said upper layer, said downwardly-extending perimetric wall having a height that about the same as a vertical distance between the upper inner bead and an upper surface of said floor portion of said receptacle, and thereby creating a void between the upper surface of said floor portion and a lower surface of the upper layer of said liner; and
a sound playback system positioned generally within said void, said sound playback system including an audio speaker, a miniature circuit board on which are mounted at least one electrochemical cell, a sound chip having an integrated circuit memory, a pair of terminals to which the audio speaker is connected, and a light-activated switch, which directs power from said electrochemical cell to said sound chip when electromagnetic radiation impinges thereon.

9. The protective case of claim 8, wherein said light-activated switch is the sole component of said sound playback system that is exposed and not completely covered by said liner.

10. The protective case of claim 8, wherein said audio speaker is adhesively bonded to said liner beneath said recess.

11. The protective case of claim 8, wherein said light-activated switch is a light-dependent resistor, and said liner includes an aperture through which light can impinge on the light-dependent resistor.

12. The protective case of claim 8, wherein said sound chip includes an EEPROM memory having multi-level storage cells.

13. The protective case of claim 8, wherein said miniature circuit board is adhesively bonded to the lower surface of the upper layer of said liner.

14. A protective case incorporating a light-activated sound chip playback system which is largely hidden beneath a liner shaped to hold a readable card, said protective case comprising:
a receptacle having an opening;
a lid sized to fit over said receptacle and cover said opening, said receptacle and said lid forming a closed container when said lid so covers said opening;
a semi-rigid liner shaped to generally fill said receptacle, said liner having a retention region for holding a readable card, said liner being formed of generally laminar material so as to leave a void between an upper interior surface of the liner and an interior bottom surface of said receptacle; and
an electrochemical-cell-powered sound playback system positioned generally within said void, said sound playback system having a light-dependent resistor which activates sound playback when said lid is removed from said receptacle.

15. The protective case of claim 14, wherein said sound playback system comprises:
an audio speaker;
at least one electrochemical cell;
a sound chip having an integrated circuit memory;
a light-dependent resistor, which functions as said light-activated switch;
a miniature circuit board on which are mounted said at least one electrochemical cell, said sound chip, and said light-dependent resistor, said miniature circuit board having a pair of terminals to which the audio speaker is connected.

16. The protective case of claim 15, wherein said audio speaker is adhesively bonded to said liner beneath said recess.

17. The protective case of claim 15, wherein said sound chip includes an EEPROM memory having multi-level storage cells.

18. The protective case of claim 14, wherein:
said receptacle has both a floor portion and a perimetric wall portion coupled to said floor portion, said perimetric wall portion having an upper inner bead which surrounds an opening of the receptacle; and
said liner is shaped to fill a portion of said receptacle beneath said upper inner bead, said liner having an upper layer that formed to provide a recess shaped to receive a readable card, said liner having a downwardly-extending perimetric wall that is continuous with said upper layer, said downwardly-extending perimetric wall having a height that about the same as a vertical distance between the upper inner bead and an upper surface of said floor portion of said receptacle, and thereby creating said void between the upper surface of said floor portion and a lower surface of the upper layer of said liner.

19. The protective case of claim 18, wherein:
said light-dependent resistor is mounted on upper surface of said miniature circuit board;
said at least one electrochemical cell and said sound chip are mounted on a bottom surface of said miniature circuit board; and
said upper layer is provided with an aperture sized to fit said light-dependent resistor, said aperture enabling light to impinge on said light-dependent resistor when said lid is removed from said receptacle.

20. The protective case of claim 19, wherein said miniature circuit board is adhesively bonded to the lower surface of the upper layer of said liner.
